(19) United States
(12) Patent Application Publication
(10) Pub. No.: US 2005/0104375 A1
(43) Pub. Date: May 19, 2005

(54) Coupling with pull-out resistance

(76) Inventor: Steven L. Thompson, Girard, KS (US)

Correspondence Address: MARK E. BROWN/CHASE LAW FIRM, L.C., 4400 COLLEGE BOULEVARD, SUITE 130, OVERLAND PARK, KS, 66211, US

(21) Appl. No.: 10/988,126

(22) Filed: Nov. 12, 2004

Related U.S. Application Data
(60) Provisional application No. 60/519,165, filed on Nov. 12, 2003.

(51) Int. Cl. F16L 19/08

(52) U.S. Cl. 285/342; 285/104; 285/339

(57) ABSTRACT

A conduit coupling device for joining conduits including a lock ring, a lock nut and a body, the body have an end adapted to receive the lock nut and the lock ring. The lock ring has an anti-shear and pull-out resisting construction adapted for resisting lock ring shear and conduit pull-out. The lock nut is adapted to receive the lock ring and compress the lock ring onto the conduit as the lock nut is received by the body end. The lock ring has proximal and distal ends with a bore being adapted to receive the conduit said bore having an inner surface F with an inner liner bonded to the inner surface of the bore. The anti-shear and pull-out resistant construction may include the inner liner having sawtooth ridges or grit particles to help resist lock ring shear and conduit pull-out and convert the conduit pull-out force to a shear force. In addition, the lock ring may include an annular flared rim forming an annular, concave shear engagement surface. Alternatively, the anti-shear and pull-out resistant construction may include an annular receiver located in either the lock ring or the conduit and a stop ring received by the annular receiver.

### BACKGROUND OF THE INVENTION

1. Field of the Invention

The present invention relates generally to couplings, and in particular to pipe couplings with lock ring constructions providing resistance to the coupled pipes and conduits from being pulled out of the couplings.

2. Discussion of the Related Art

Couplings and fittings of various types are used for joining pipes and conduits. For example, Thompson U.S. Pat. No. 5,180,197 discloses a pipe jointing system with a tubular coupling having a rigid, outer layer receiving an elastomeric inner layer having annular ridges for pull-out resistance and sealing. Thompson U.S. Pat. No. 5,833,276 discloses a double-ended coupling with lock rings adapted for compression onto the pipe ends by lock nuts, which are threaded onto the coupling body ends. The compressive forces imparted by the lock rings restrain the pipe ends within the coupling body.

There is a significant demand for couplings that can join conduit without solvent, adhesive bonding, fusion welding or special installation equipment. For example, electrical and telecommunications conduits are commonly joined by such couplings and fittings. In recent years fiber optic cable networks have been installed in many parts of the country. Such networks are commonly buried, thus creating significant demand for couplings adapted to permanently join sections of plastic (e.g., HDPE, etc.) conduit in below-grade conditions. The fiber optic cables are commonly blown through the conduit by pressurized air, whereby the conduits and their fittings have to be able to withstand air pressures of 100 PSI or more. Watertightness is another criteria for many such subsurface telecommunications conduit installations, which must prevent groundwater infiltration. Therefore, fiber optic cable conduit fittings are preferably fluid-tight and provide considerable resistance to pull-out. It is also preferred that they be adapted for efficient installation without tools or solvent adhesives.

Conduit sections can also be securely coupled together by providing each section with an enlarged, bell end for telescopically receiving the corresponding end of an adjacent conduit section. Similar performance criteria, such as fluid-tight construction and pull-out resistance, apply to such self-joining conduit sections when they are used for fiber optic cables and other, similar applications.

Heretofore there has not been available a coupling with the advantages and features of the present invention.

### BRIEF DESCRIPTION OF THE INVENTION

In the practice of one aspect of the present invention, a conduit coupling construction includes a coupling body threadably mounting a pair of lock nuts on its ends. Conduit ends are passed through the lock nuts and into the coupling body. Each lock nut receives a respective lock ring adapted for compression onto a respective conduit. The lock ring transforms an axial force on the conduit to a shear force to enhance gripping for pull-out resistance.

### BRIEF DESCRIPTION OF THE DRAWINGS

The drawings constitute a part of this specification and include exemplary embodiments of the present invention and illustrate various objects and features thereof.

FIG. 1 is a fragmentary, exploded, perspective view of a coupling embodying an aspect of the present invention.

FIG. 2 is a perspective view of a prior art coupling lock ring.

FIG. 3 is a perspective view of a coupling lock ring embodying an aspect of the present invention.

FIG. 4 is a perspective view of a coupling lock ring embodying another aspect of the present invention.

FIG. 5 is a perspective view of a coupling lock ring embodying another aspect of the present invention.

FIG. 6 is a cross-sectional view of the lock ring shown in FIG. 3.

FIG. 7 is a cross-sectional view of the lock ring shown in FIG. 4.

FIG. 8 is a cross-sectional view of the lock ring shown in FIG. 5.

FIG. 9 is an exploded view of a coupling and first and second conduit sections adapted for connection thereby.

FIG. 10 is a side elevational view of the coupling and the conduit sections.

FIG. 11A is an enlarged, cross-sectional view of a coupling and a conduit section, showing an aspect of the invention.

FIG. 11B is an enlarged, cross-sectional view of a coupling and a conduit section, showing another aspect of the invention.

FIG. 11C is an enlarged, cross-sectional view of a coupling and a conduit section, showing another aspect of the invention.

FIG. 11D is an enlarged, cross-sectional view of a coupling and a conduit section, showing another aspect of the invention.

FIG. 11E is an enlarged, cross-sectional view of a coupling and a conduit section, showing another aspect of the invention.

FIG. 12 is an enlarged, cross-sectional view of a coupling and a conduit section, showing another aspect of the invention.

FIG. 13 in is an enlarged, cross-sectional view of a coupling with a lock ring having multiple stop rings, showing another aspect of the invention.

FIG. 14 is an enlarged, cross-sectional view of the coupling shown in FIG. 13, showing a stop ring thereof in an uncompressed position.

FIG. 15 in is an enlarged, cross-sectional view of the coupling shown in FIG. 13, showing the stop ring thereof in a compressed position.

FIG. 16 is a cross-sectional view of a coupling comprising another aspect of the present invention, formed in a pipe bell end.

### DETAILED DESCRIPTION OF THE INVENTION

As required, detailed embodiments and/or aspects of the present invention are disclosed herein; however, it is to be understood that the disclosed embodiments/aspects are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

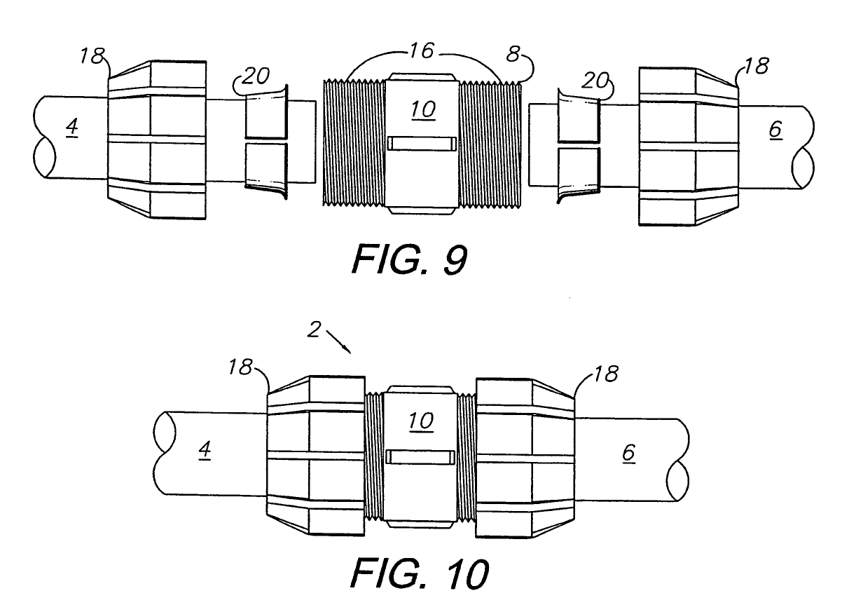

Referring to the drawings in more detail, the reference numeral 2 generally designates a coupling for joining first and second conduits 4, 6 in a fluid-tight, pull-out resistant construction (FIGS. 9 and 10). The coupling 2 generally includes a body 8, which can be generally similar to the coupling body described in Thompson U.S. Pat. No. 5,833,276, which is incorporated herein by reference. The body 8 includes: an outer, hard plastic sleeve 10; an inner, elastomeric liner 12 with annular sealing ridges 14; and threaded ends 16. Lock nuts 18 are threadably received on the body ends 16 and compress lock rings 20 onto the conduits 4, 6.

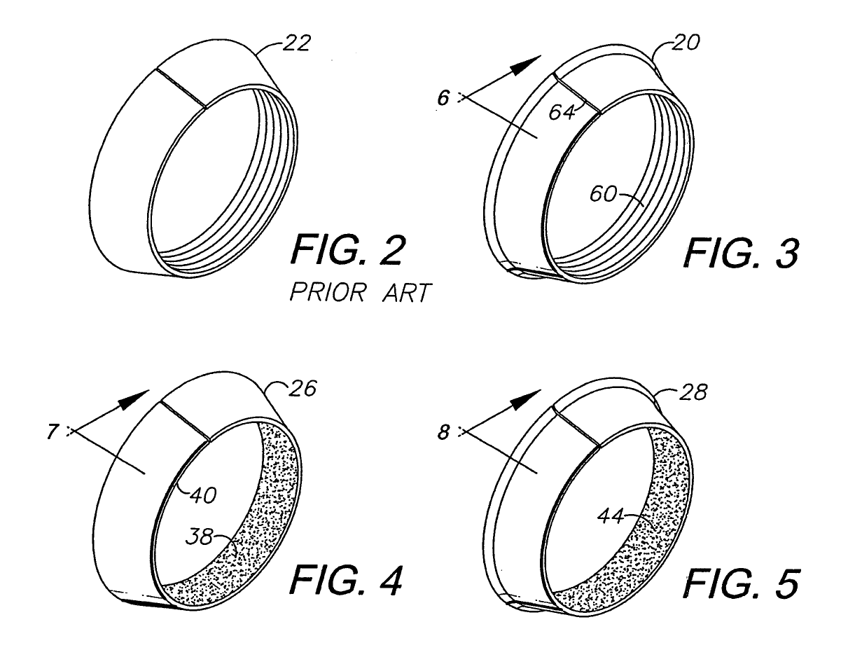

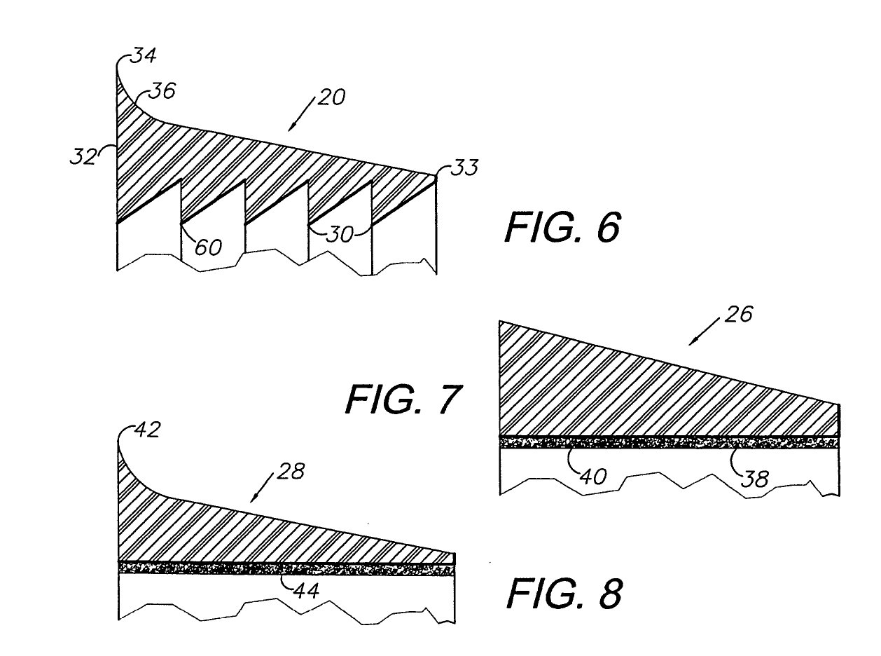

FIG. 2 shows a prior art lock ring 22 with a generally frusto-conical configuration. FIGS. 3-5 show improved lock rings 20, 26, 28 respectively, which embody aspects of the present invention. FIG. 6 shows the lock ring 20, which includes annular, sawtooth-shaped ridges 30 in a bore 60. The lock ring 20 also includes a proximal end 32 and a distal end 33. The proximal end 32 includes a flared rim 34, which projects outwardly from a frusto-conical outer surface and forms an annular, concave shear engagement surface 36. The lock rings 20, 26, 28 are discontinuous at compression gaps 64, which extend longitudinally between their respective ends and accommodate adjustments to their respective diameters. FIG. 7 shows the lock ring 26, which includes an annular inner liner 38 comprising grit particles, such as sandblasting grit, bonded to the inner surface of a lock ring bore 40 by a suitable adhesive or binder. FIG. 8 shows the lock ring 28 with a flared rim 42 similar to the flared rim 34, and a grit liner 44 similar to the grit liner 38.

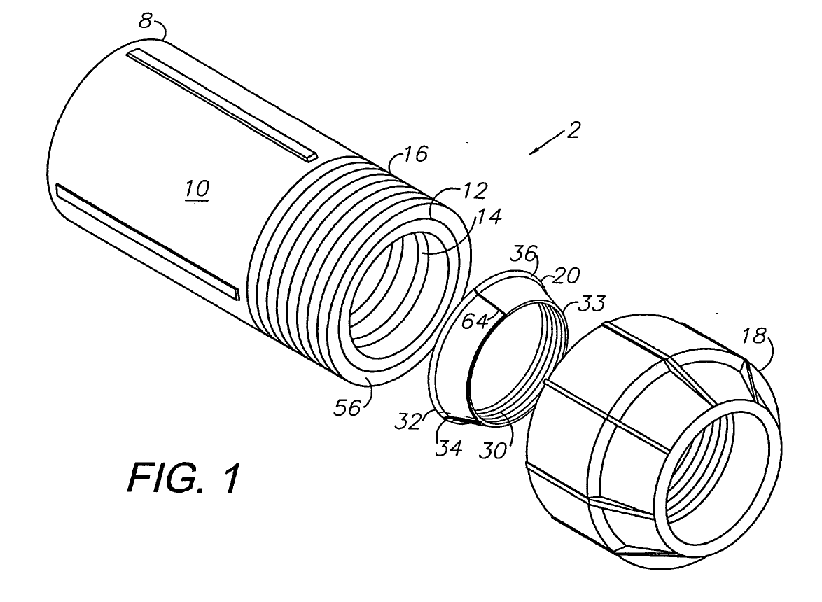

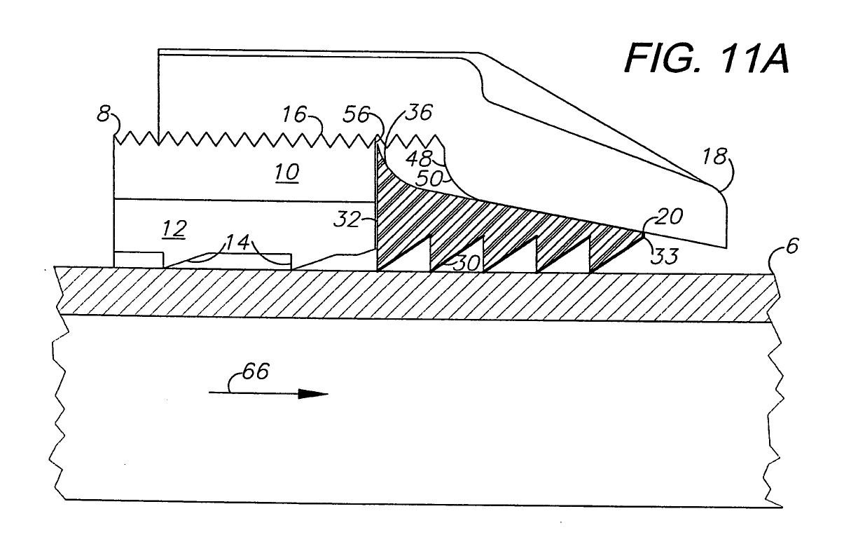

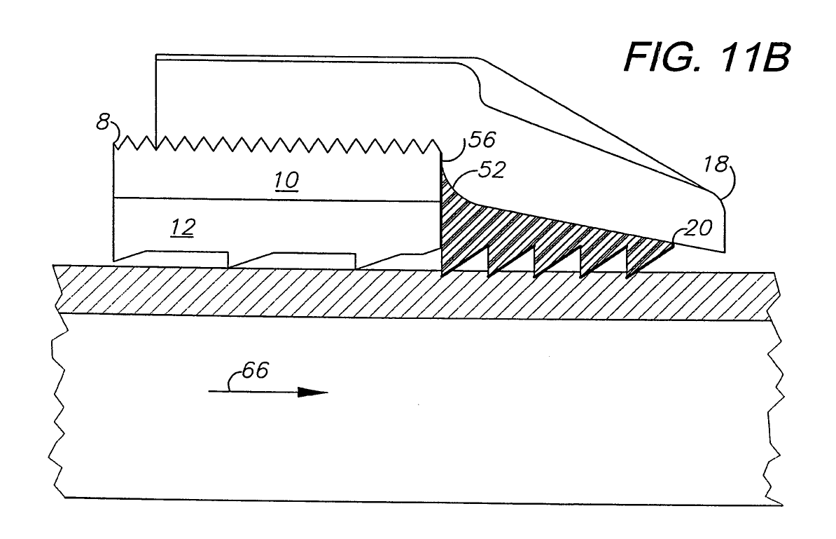

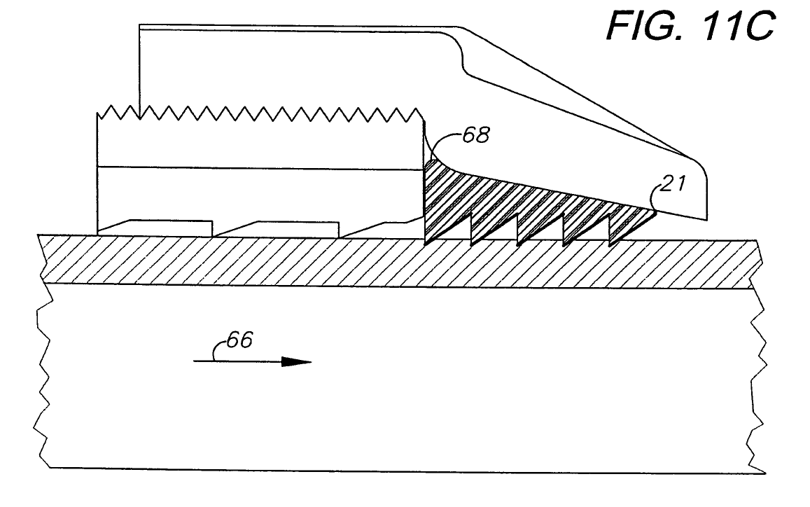

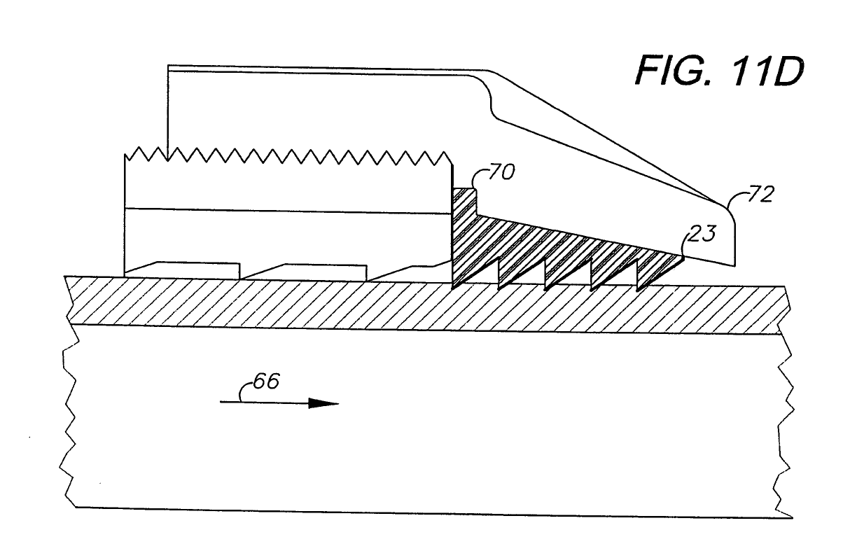

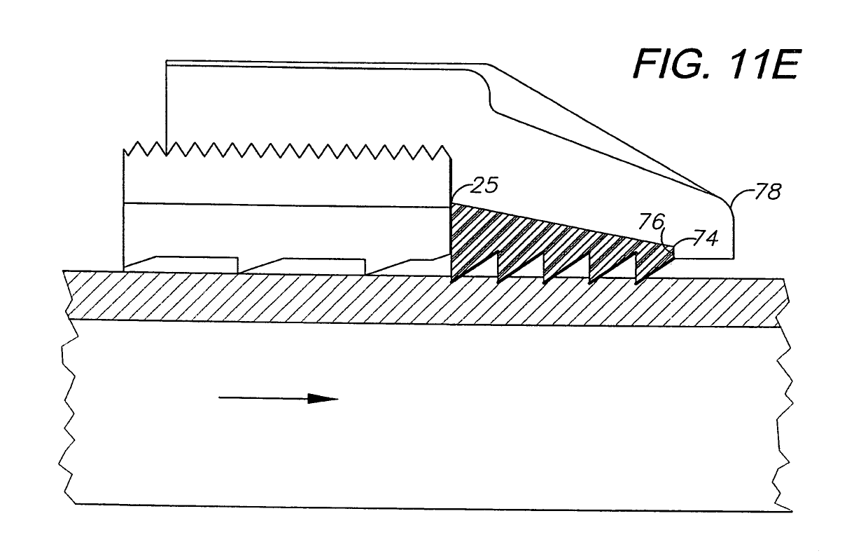

In operation, the lock rings 20, 26, 28 provide a gripping, pull-out resistant restraining force on the conduit sections 4, 6 by transforming compression forces exerted by the lock nuts 18 to shear forces associated with and enhanced by the configurations and materials of the lock rings 20, 26, 28. Sequential assembly of the coupling 2 is shown in FIGS. 9 and 10, wherein the lock nuts 18 are threadably received on the coupling body ends 16, thereby capturing the lock rings 20, 26, 28 in the final assembly shown in FIG. 10. FIG. 11A shows a lock ring 20 engaging conduit 6 within a lock nut 18 along frusto-conical ring and nut engagement surfaces 36, 48 respectively. The lock nut 18 includes a convex shoulder 50 with a configuration corresponding to the flared rim 34 whereby an annular, shear engagement contact 52 is formed between the flared rim 34 and the shoulder 50. The lock ring 20 proximal end 32 abutts a coupling body end 56. The lock ring 20 includes a bore 60 with annular ridges 30 adapted for penetrating the conduit outer surface with the lock nut 18 fully tightened and the lock ring 20 fully engaged (FIG. 11B). As shown in FIG. 11B, threading the lock nut 18 onto the body end 16 tends to exert a “hoop tension” force, which biases the lock ring 20 radially inwardly into the conduit 6, thereby closing a compression gap 64 formed in the lock ring 20 and extending longitudinally between its ends 32, 33 (FIGS. 1 and 9). The engagement of the flared rim 34 on the shoulder 50 restrains the lock ring 20 on the lock nut 18 in the position shown in FIG. 11B. Pull-out force along the force arrow 66 converts to shear force at the ring-to-nut shear engagement contact 52, thus limiting the hoop tension, which can otherwise crack the nut 18 and permit the lock ring 20 to be extruded through the distal end of the nut 18.

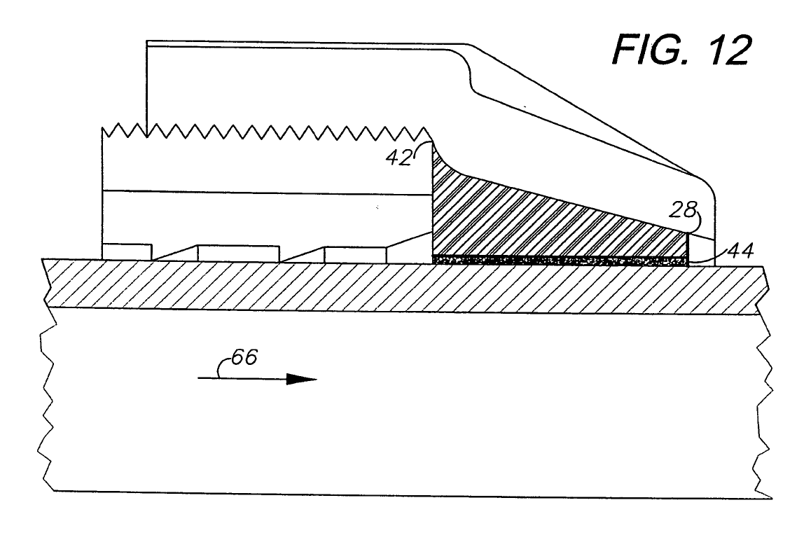

FIG. 11C shows a modified or alternative aspect of the invention including a lock ring 21 with a radiused edge 68. FIG. 11D shows another modified or alternative aspect of the invention including a lock ring 23 with a rectangular cross-sectional rim 70, which is received in a shoulder with a corresponding configuration formed in a lock nut 72. FIG. 11E shows another modified lock ring 25 with a squared-off distal end 74, which is adapted for abutting a distal shoulder 76 formed in a modified lock nut 78. FIG. 12 shows the lock ring 26 installed in the lock nut 18, with the grit liner 38 frictionally engaging the conduit 6.

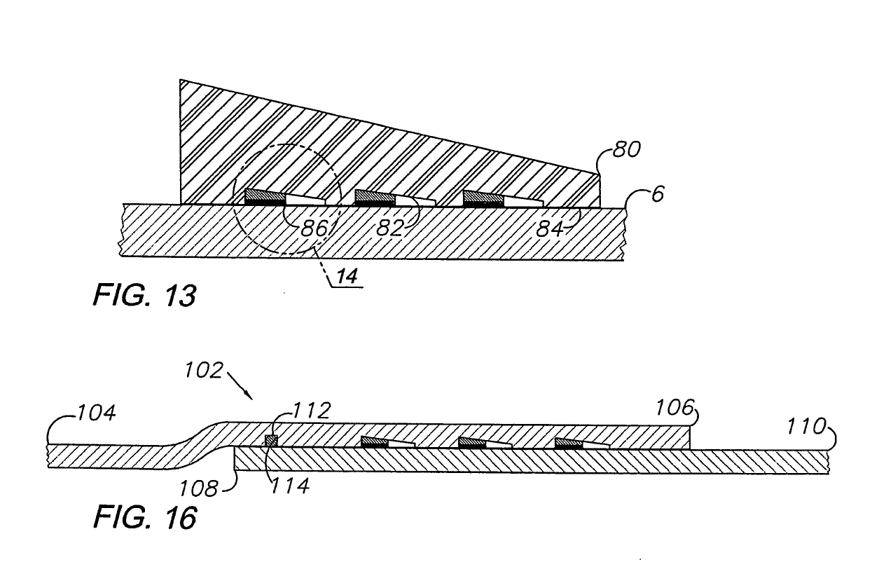

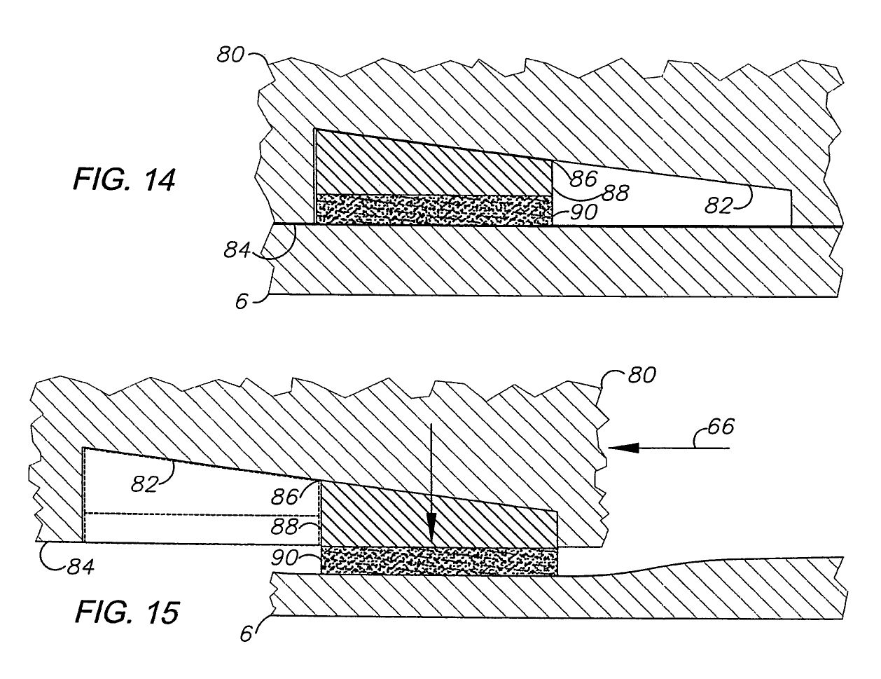

FIG. 13 shows another aspect of the invention, which includes a modified lock ring 80 with multiple, annular, tapered receivers 82 opening onto an inner, bore surface 84 of the ring 80. Each receiver 82 receives a stop ring 86 with a tapered configuration corresponding to the tapered configuration of the receivers 82. Each stop ring 86 includes an outer, plastic band 88 and an inner, grit material band 90. Thus, the stop rings 86 are initially located as shown in FIG. 14, i.e. at the larger ends of the receivers 82 with minimal compression, if any, exerted on the conduit 6. A pull-out force on the conduit 6 tends to slide the stop rings 86 to the smaller ends of the receivers 82, thus applying leverage to exert maximum compressive force through the stop rings 86 against the conduit 6 (FIG. 15).

FIG. 16 shows a modified coupling 102 comprising a modified or alternative aspect of the present invention and comprising a conduit 104 with an enlarged bell end 106 adapted to telescopically receive a plain end 108 of a conduit 110. Multiple stop rings 86 are located in corresponding annular, tapered receivers 82, as described above. An O-ring 112 is received in an annular groove 114. Various configurations of the modified coupling 102 can be provided within the scope of the present invention. For example, one or more of the receivers 82 can be formed in the conduit plain end 108. The groove 114 and the O-ring 112 can likewise be located in the conduit plain end 108.

It will be appreciated that the pull-out resistant coupling can be configured in various alternative aspects and embodiments within the scope of the present invention.

1. A conduit coupling device for joining conduit, said conduit coupling device comprising:
a lock ring adapted to receive the conduit; and
said lock ring having an anti-shear and pull-out resisting construction adapted for resisting lock ring shear and conduit pull-out.

2. The device according to claim 1 further including a body and said lock ring being adapted for connection to the body.

3. The device according to claim 1 wherein the lock ring further includes:
a proximate end;
a distal end separated from the proximal end;
a bore having an inner surface, said bore being adapted to receive the conduit;
an outer surface extending longitudinally from the proximal end to the distal end, the outer surface being generally frusto-conically shaped; and
an inner liner bonded to the inner surface of the bore.

4. The conduit coupling device according to claim 3 further including a compression gap extending between the proximal end and the distal end, the lock ring being discontinuous at the compression gap.

5. The conduit coupling device according to claim 3 wherein said anti-shear construction comprises an annular flared rim located near the lock ring proximal end, said rim projecting outwardly from the frusto-conical outer surface.

6. The conduit coupling device according to claim 5 wherein the rim forms an annular, concave shear engagement surface.

7. The conduit coupling device according to claim 3 wherein said anti-shear construction comprises annular saw-tooth shaped ridges located adjacent to the inner surface of the bore.

8. The conduit coupling device according to claim 3 wherein said anti-shear construction comprises said inner liner including grit particles.

9. The conduit coupling device according to claim 3 wherein said anti-shear construction comprises:
an annular receiver located in one of the lock ring and the conduit; and
a stop ring received by the annular receiver and adapted for compression between the conduit and the lock ring.

10. The conduit coupling device according to claim 9 wherein the stop ring includes:
an outer band;
an inner band bonded to the outer band wherein one of the inner band and the outer band slides relative to the lock ring and the conduit;
wherein one of the inner band and the outer band is adapted for fixedly securing one of the conduit and the lock ring when the device experiences a pull-out force.

11. The conduit coupling device according to claim 10 wherein the outer band is plastic and the inner band is comprised of a grit material.

12. The conduit coupling device according to claim 1 wherein the lock ring is biased radially inwardly towards the conduit.

13. The conduit coupling device according to claim 5 wherein the lock ring rim has a radiused edge.

14. The conduit coupling device according to claim 2 wherein the coupling device further includes:
a lock nut adapted to receive the lock ring;
said body having an end being adapted to receive the lock nut; and
said lock nut being adapted to compress the lock ring onto the conduit as the lock nut is received by the body end.

15. The conduit coupling device according to claim 14 wherein the body end and the lock ring are threaded such that the lock nut is threadably received by the body end.

16. The conduit coupling device according to claim 14 wherein the lock ring further includes a compression gap adapted to be closed when the lock nut is threaded onto the body end.

17. The conduit coupling device according to claim 14 wherein the lock nut further includes:
a shoulder with a configuration corresponding to the lock ring; and
a lock nut engagement surface adapted to engage the lock ring, wherein the anti-shear and pull-out resisting construction converts the conduit pull-out force to a shear force at the outer surface of the lock ring.

18. The conduit coupling device according to claim 17 wherein the anti-shear construction comprises said lock ring having a rectangular cross-sectional rim adapted to be received in said shoulder.

19. The conduit coupling device according to claim 15 wherein the anti-shear construction comprises:
said lock ring having a squared-off distal end; and
the lock nut having a distal shoulder adapted to engage said lock ring with the squared-off distal end.

20. A conduit coupling device for joining conduit, said conduit coupling device comprising:
a body;
said body having a threaded end being adapted to receive the lock ring;
a lock ring circumscribing a bore, said lock ring being adapted to receive the conduit;
a frusto-conical shaped lock nut with a maximum and a minimum diameter end, said lock nut being adapted to receive the lock ring and compress the lock ring onto the conduit as the lock nut is threadably received by the body end wherein the maximum diameter end is threadably received by the threaded body end and the minimum diameter end extends outwardly from the body;
said lock ring having a proximal end separated from a distal end, a frusto-conical shaped outer surface extending longitudinally from the proximal end to the distal end, a bore being adapted to receive the conduit, said bore having an inner surface with an inner liner bonded to the inner surface of the bore;
said lock ring including a compression gap extending between the proximal end and the distal end, the lock ring being discontinuous at the compression gap;
said lock ring having an anti-shear and pull-out resisting construction adapted for resisting lock ring shear and conduit pull-out, said anti-shear construction comprising an annular flared rim located near the lock ring proximal end, said rim projecting outwardly from the frusto-conical outer surface wherein the rim forms an annular, concave shear engagement surface; and
said lock nut further including a bore, a shoulder and a lock nut engagement surface, the bore having annular saw-toothed shaped ridges, the shoulder having a corresponding configuration to the lock ring and the lock nut engagement surface being adapted to engage the lock ring wherein the anti-shear and pull-out resisting construction converts the conduit pull-out force to a shear force at the outer surface of the lock ring.

21. The conduit coupling device according to claim 20 wherein said coupling device further includes:
a body with an interior, an exterior and an annular sealing ridge, said body being comprised of an outer, hard plastic sleeve positioned on the exterior of the body; and
an inner, elastomeric liner joined to the interior of the body and separated from the sleeve by the body, said body annular sealing ridge being located in proximity to the liner and distributed throughout the length of the liner.
